(19) United States
(12) Patent Application Publication
(10) Pub. No.: US 2006/0292271 A1
(43) Pub. Date: Dec. 28, 2006

(54) Spray coating method and apparatus

(76) Inventor: Peter King, Oxford (GB)

Correspondence Address: WENDEROTH, LIND & PONACK, L.L.P., 2033 K STREET N. W., SUITE 800, WASHINGTON, DC, 20006-1021, US

(21) Appl. No.: 11/166,175

(22) Filed: Jun. 27, 2005

(51) Int. Cl. A23B 4/056

(52) U.S. Cl. 426/235

(57) ABSTRACT

A method of coating a food product, the method comprising spraying a coating substance at the product whilst the product is falling under gravity, so as to coat at least a first surface of the product. The overspray is electrostatically charged using a needle electrode, wherein the charged coating substance can be attracted back towards the product after the product has landed on a grounded exit conveyor so as to coat a further surface or surfaces thereof.

The present invention relates to a method and apparatus for coating food products and is applicable in particular, though not necessarily, to a method and apparatus for coating food products such as meat and meat based products with a flavouring.

A variety of methods and systems are currently used for applying a coating to food products, where the coating may be a flavouring (e.g. spice), batter, oil, or the like. In a typical system, products are transported by a conveyor to a tray containing the coating substance. The products pass through the tray resulting in the underside of the product being coated. Simultaneously, the products are sprayed from above using a sheet sprayer, resulting in the upper surface and the sides of the products being coated. A serious problem with this approach is that the spray tends to contaminate a wide area including the conveyors, the sprayer itself, and surrounding areas. This results in an unpleasant working environment for operators, wastage of the coating product, and a necessity to thoroughly clean equipment and surfaces before a change of coating product can be implemented (often the same production line is used to produce products with different flavourings). Furthermore, this approach tends to result in relatively poor product coating, particularly of product sides and other “hidden” areas.

It is an object of the present invention to overcome or at least mitigate the above noted disadvantages of conventional food product coating methods and systems.

According to a first aspect of the present invention there is provided a method of coating a food product, the method comprising;

spraying a coating substance at the product so as to coat at least a first surface of the product; and

electrostatically charging the overspray, wherein the charged coating substance can be attracted back towards the product to coat a further surface or surfaces thereof. Embodiments of the present invention tend to minimise the contamination of equipment and areas with the coating substance. Excellent product coverage can also be achieved.

In an embodiment of the invention, the product is allowed to fall from a first to a second conveyor, said step of spraying a coating substance at the product being carried out whilst the product is falling, thereby coating an underside of the product. Preferably, at least a surface of the second conveyor is formed of generally conductive material and is connected to a fixed potential, e.g. ground potential. The product on the second conveyor is thereby connected to the same fixed potential. The charged coating substance is attracted towards the second conveyor and the product, thereby coating an upper surface of the product.

The coating substance may be a liquid or slurry, in which case spraying may be achieved using a suitable pump and spray nozzle. The coating substance may be a powder, in which case spraying may be achieved by exposing the coating substance to a pressurised gas jet.

Preferably, the method of the invention is carried out within a substantially closed chamber, with the step of electrostatically charging the overspray being implemented by means of at least one needle electrode located at or adjacent to the upper, inner surface of the chamber. More preferably, said at least one needle electrode is located above said second conveyor.

According to a second aspect of the present invention there is provided apparatus for coating a food product with a coating substance, the apparatus comprising:

spray means for spraying the food product with the coating substance;

charging means for electrostatically charging the overspray; and

means for coupling the product to a fixed potential, whereby the charged coating substance is attracted towards the product.

In one embodiment of the invention, the apparatus comprises a substantially closed chamber within which said spray means, charging means, and means for coupling the product to a fixed potential. Preferably, the chamber is constructed substantially from plastics or other non-conducting material.

The apparatus preferably comprises first and second conveyors, the first conveyor conveying the product into the chamber and terminating above the first conveyor so that in use the product travels along the first conveyor and falls under gravity onto the second conveyor. The spray means is located substantially beneath the first conveyor and arranged to spray an underside of the product as it falls. The second conveyor is coupled to a fixed potential, e.g. ground potential, so as to ground the product being conveyed, thereby attracting the charged coating substance onto the product. The second conveyor terminates at a location outside of the chamber.

Preferably, said charging means comprises at least one needle electrode which in use is charged to a suitably high potential. More preferably, the needle electrode is located at or adjacent to the upper, inner surface of the chamber, above the second conveyor.

For a better understanding of the present invention and in order to show how the same may be carried into effect reference will now be made, by way of example, to the accompanying drawings in which:

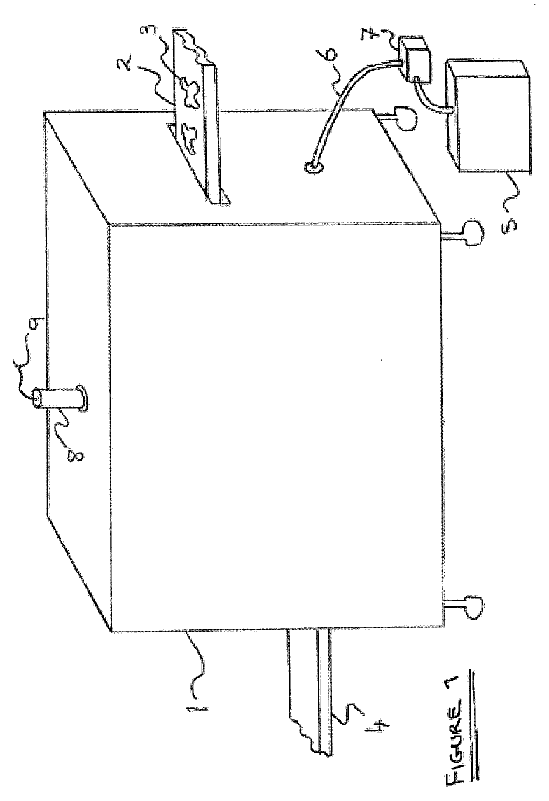

FIG. 1 illustrates a food product coating system;

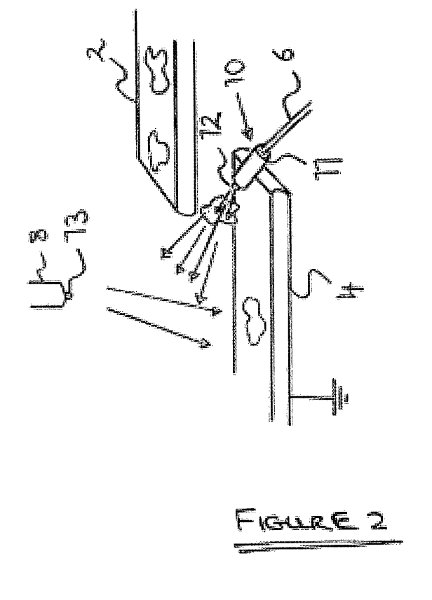

FIG. 2 illustrates certain components of the food product coating system of FIG. 1; and

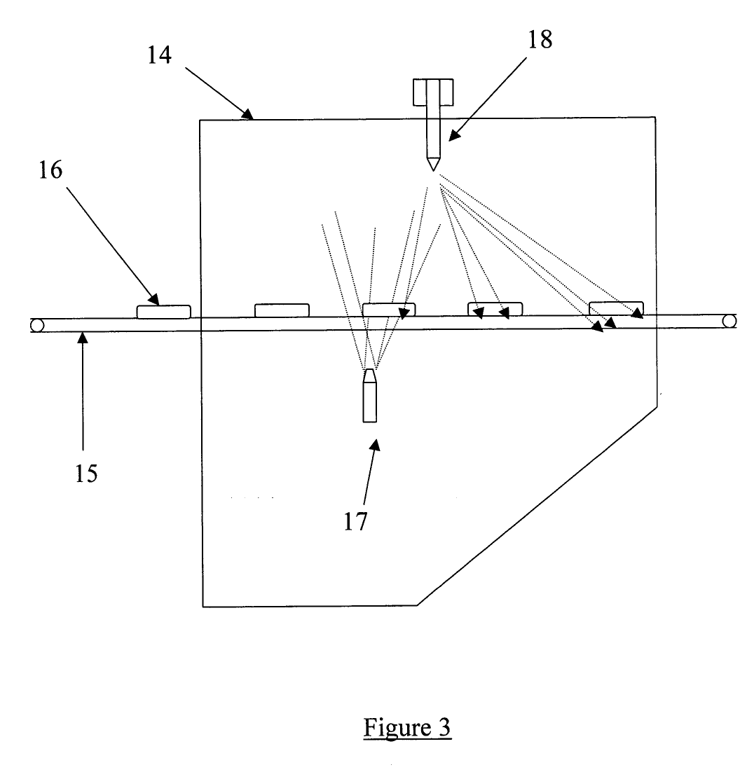

FIG. 3 an alternative food product coating system.

With reference firstly to FIG. 1, there is shown a food product coating system comprising an enclosure 1 substantially formed from a non-conducting and biologically “clean” plastics material. The enclosure is mounted on wheels so as to make the system portable. A first opening is provided in one side of the enclosure 1 to allow for a first product conveyor 2. This conveyor 2 conveys products 3 to be coated into the enclosure. A second opening is provided in the opposite side of the enclosure 1 to allow for a second product conveyor 4. This conveyor 4 conveys coated products out of the enclosure. The system will typically be integrated into a production line process, with products being introduced to the entry conveyor 3 from some pre-processing equipment and removed from the exit conveyor 4 for packaging.

The entry and exit conveyors 2,4 are typically of the endless conveyor type, in which case the conveyor belts will be provided by plastic sheets mounted on runners. At least the second conveyor 4 is covered with a wire mesh (not shown) which is connected to ground potential (e.g. through a supporting metal frame). Alternatively, the conveyor belts may be of metal chain-link construction, or may be inclined and/or vibrating chutes, again with at least the second conveyor being connected to ground potential.

A container 5 contains a liquid or slurry coating product which is fed into the enclosure via a tube 6 using a peristaltic pump 7. An electrode housing 8 is attached to the upper surface of the enclosure, and receives a high voltage feed via a cable 9.

With reference to FIG. 2, a number of components internal to the enclosure 1 will now be described. The entry conveyor 2 terminates at a point above the exit conveyor 4, such that products will fall off the end of the entry conveyor and land on the exit conveyor in a predictable manner, e.g. with the product underside on the entry conveyor remaining the underside on the exit conveyor. A significant vertical gap, e.g. 10 cm, is provided between the two conveyors. Fixed beneath the entry conveyor 2 is spray apparatus 10 comprising a plastics body 11 arranged to receive the tube 6 conveying the liquid or slurry coating product. The tube passed through the body 11 and is coupled at an end of the body to a spray nozzle 12. The spray nozzle is arranged in use to generate a fine, directed mist. The spray is aimed at the gap between the conveyors, travelling in the direction indicated by the upward pointing arrows in FIG. 2.

The electrode housing 8 introduces a needle electrode 13 into the enclosure 1, at a location above the second conveyor and generally in line with the spray direction. The electrode is charged (by a voltage supply not shown in the Figures) to a voltage in the region of 85 KV. This voltage generates a substantial electric filed towards the top of the enclosure.

In use, products falling from the entry conveyor 2 are sprayed on their undersurface with the coating substance during their fall. Products land on this undersurface on the exit conveyor 4. The overspray, that is the spray which passes around the products, travels towards the electric field generated by the needle electrode 13. The spray droplets tend to become electrostatically charged and fall downwards under the effects of gravity and an attraction towards the exit conveyor and products which are at ground potential. The charged droplets tend to attach to the exposed surfaces of the products including the upper and side surfaces.

The substantially closed nature of the enclosure 1 results in very little coating substance leaking out of the enclosure and contaminating other areas of the production line. In addition, within the enclosure 1, contamination tends to be confined to the surface of the second conveyor, making it relatively easy to clean the apparatus, e.g. prior to a change in the type of coating substance in use.

With reference now to FIG. 3, an alternative embodiment of the invention will now be described. The product coating system again comprises an enclosure 14 which contains the product coating components. A chain link conveyor 15 for transporting food products 16 along a production line enters and exits the enclosure 14 through respective openings. A powder spray nozzle 17 is located beneath the conveyor and receives powder blown through a venturi tube (not shown) from a bulk powder container. The nozzle directs the powder onto the underside of the conveyor. The bulk of the powder passes through the chain link conveyor, and some of it will impact on the undersides of the food products, providing a coating on those undersides. The remainder of the powder passing through the conveyor will continue travelling towards the top of the enclosure.

An electrostatic charging head 18 of the type already described is located towards the top of the enclosure, generally above the nozzle 17. The head 18 creates a high electric field in the upper regions of the enclosure, such the much of the powder overspray is charged by the field. The conveyor 15 is grounded, and hence so are the food products transported by the conveyor. The charged overspray powder will be attracted back towards the conveyor and the food products, coating the top surfaces (and to some extent the sides) thereof.

It will be appreciated by the person of skill in the art that various modifications may be made to the above described embodiment without departing from the scope of the present invention.

1. A method of coating a food product, the method comprising;
spraying a coating substance at the product so as to coat at least a first surface of the product; and
electrostatically charging the overspray, wherein the charged coating substance can be attracted back towards the product to coat a further surface or surfaces thereof.

2. A method according to claim 1 and comprising allowing the product to fall from a first to a second conveyor, said step of spraying a coating substance at the product being carried out whilst the product is falling, thereby coating an underside of the product.

3. A method according to claim 2, wherein at least a surface of the second conveyor is formed of generally conductive material and is connected to ground potential, the product on the second conveyor thereby being connected to ground potential.

4. A method according to claim 1, wherein the method is carried out within a substantially closed chamber, with the step of electrostatically charging the overspray being implemented by means of at least one needle electrode located at or adjacent to the upper, inner surface of the chamber.

5. A method according to claim 4, wherein at least a surface of the second conveyor is formed of generally conductive material and is connected to ground potential, and the product on the second conveyor is thereby being connected to ground potential, wherein said at least one needle electrode is located above said second conveyor.

6. A method according to claim 1, wherein said food product is transported on a conveyor, the coating substance being sprayed through the conveyor onto a first side of the product, the charged overspray being attracted back to the food product so as to coat the other side.

7. Apparatus for coating a food product with a coating substance, the apparatus comprising:
spray means for spraying the food product with the coating substance;
charging means for electrostatically charging the overspray; and
means for coupling the product to a fixed potential, whereby the charged coating substance is attracted towards the product.

8. Apparatus according to claim 6, wherein the apparatus comprises a substantially closed chamber within which said spray means, charging means, and means for coupling the product to a fixed potential.

9. Apparatus according to claim 7, wherein the chamber is constructed substantially from plastics or other non-conducting material.

10. Apparatus according to claim 6 and comprising first and second conveyors, the first conveyor conveying the product into the chamber and terminating above the first conveyor so that in use the product travels along the first conveyor and falls under gravity onto the second conveyor, the spray means being located substantially beneath the first conveyor and arranged to spray an underside of the product as it falls.

11. Apparatus according to claim 9, the second conveyor being coupled to ground potential, so as to ground the product being conveyed, thereby attracting the charged coating substance onto the product.

12. Apparatus according to claim 6, said charging means comprising at least one needle electrode which can be coupled to a high voltage source.

13. Apparatus according to claim 11, the needle electrode being located at or adjacent to the upper, inner surface of the chamber, above the second conveyor.

14. Apparatus according to claim 7 and comprising a conveyor for transporting the food product, the conveyor allowing the passage of sprayed coating substance therethrough, wherein the spray means and the charging means are disposed on opposite sides of the conveyor and the spray means is arranged to direct at least a proportion of its spray through the conveyor.

15. Apparatus according to claim 14, wherein the conveyor is a chain link conveyor.
